(19) United States
(12) Patent Application Publication
(10) Pub. No.: US 2015/0181088 A1
(43) Pub. Date: Jun. 25, 2015

(54) IP CAMERA APPARATUS

(71) Applicant: GeoVision Inc., Taipei (TW)

(72) Inventors: Chih-Ming Wu, New Taipei City (TW); Chun-Kai Hsu, New Taipei City (TW); Li-Ting Chao, New Taipei City (TW)

(73) Assignee: GeoVision Inc., Taipei (TW)

(21) Appl. No.: 14/140,485

(22) Filed: Dec. 25, 2013

(51) Int. Cl. H04N 5/225; H04N 7/14; H04N 1/00

(52) U.S. Cl. CPC H04N 5/2254; H04N 1/00299; H04N 7/141

(57) ABSTRACT

An IP camera apparatus is provided. The IP camera apparatus includes a base module, a power module, a lens module, and a plurality of first functional modules. The base module is formed in a housing having a first docking side. The base module includes a control unit and a plurality of connecting ports is disposed on the first docking side. The power module is detachably mounted to the base module. The lens module is connected to the base module. The plurality of first functional modules is detachably and interchangeably mounted to the plurality of connecting ports on the first docking side of the housing. Each first functional module is formed into a first unified block.

### BACKGROUND OF THE INVENTION

1. Field of the Invention

The invention relates to an IP camera apparatus, and more particularly, to an IP camera apparatus with expandable features in the form of decentralized docking modules.

2. Description of the Prior Art

An Internet protocol camera, or IP camera, is a type of digital video camera commonly employed for surveillance, and which unlike analog closed circuit television (CCTV) cameras can send and receive data via a computer network and the Internet. Although most cameras that do this are webcams, the term “IP camera” or “netcam” is usually applied only to those used for surveillance.

Advancement in modern technology and escalation of consumer's need bring to the incorporation of various features into an existing IP camera apparatus. People can easily find an IP camera product incorporated with features like network connectivity, audio input/output, many types of sensors, etc. However, according to the prior art, features are integrated into the IP camera apparatus in a customized sense. Limited expandability of features is provided.

### SUMMARY OF THE INVENTION

The invention is directed to an IP camera apparatus with extensible functional modules implemented in the form of a unified block.

According to one objective of the invention, an embodiment of the invention provides an IP camera apparatus including a base module, a power module, a lens module, and a plurality of first functional modules. The base module is formed in a housing having a first docking side. The base module includes a control unit and a plurality of connecting ports is disposed on the first docking side. The power module is detachably mounted to the base module. The lens module is connected to the base module. The plurality of first functional modules is detachably and interchangeably mounted to the plurality of connecting ports on the first docking side of the housing and each first functional module is formed into a first unified block.

According to the embodiment, the lens module of the IP camera apparatus is detachably mounted to one connecting port on the first docking side of the housing and is formed into the first unified block.

According to the embodiment, each first functional module has length of M times a first unit length along a mounting side of the first functional module and the length of the first docking side is N times the first unit length, wherein M, N are positive integers and M is no greater than N, and wherein N connecting ports are disposed on the first docking side.

According to the embodiment, the first docking side has thickness at least two times the thickness of each first functional module and the plurality of connecting ports are disposed on the first docking side in at least two rows.

According to the embodiment, the housing further includes a second docking side and a plurality of connecting ports is disposed on the second docking side.

According to the embodiment, the IP camera apparatus further includes a plurality of second functional modules detachably and interchangeably mounted to the plurality of connecting ports on the second docking side of the housing, each second functional module formed into a second unified block.

According to the embodiment, the lens module is detachably mounted to one connecting port on the second docking side of the housing and is formed into the second unified block.

According to the embodiment, each second functional module has length of X times a second unit length along a mounting side of the second functional module and the length of the second docking side is Y times the second unit length, wherein X, Y are positive integers and X is no greater than Y, and wherein Y connecting ports are disposed on the second docking side.

According to the embodiment, the first docking side and the second docking side are equal in length.

According to the embodiment, the second docking side has thickness at least two times the thickness of each second functional module and the plurality of connecting ports are disposed on the second docking side in at least two rows.

According to the embodiment, the plurality of connecting ports on the first docking side and the second docking side are universal connecting ports cooperatively and adaptively to connect to the plurality of first functional modules and the plurality of second functional modules.

According to the embodiment, each of the first functional modules and the second functional modules is selected from one of the following: an audio box, an access control unit, a fire detector, a Wi-Fi module, a GPS module, a 3G communication module, and a 4G/LTE communication module.

According to the embodiment, the power module is a vehicle power module, an AC/DC power module, or a power-over-Ethernet (POE) module.

According to the embodiment, the IP camera apparatus further includes a base mount where the base module is mounted thereon and a plurality of mounting kits where the plurality of first functional modules and a plurality of second functional modules is mounted thereon respectively, each of the mounting kit coupled with the base mount in a detachable way.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an embodiment of an IP camera apparatus according to the invention.

FIG. 2 is a schematic diagram showing an illustrative block function diagram of the IP camera apparatus of FIG. 1 according to the invention.

FIG. 3 shows dimensional relations between the docking sides of the housing and the functional modules.

FIG. 4 is a schematic diagram of another embodiment of the IP camera apparatus according to the invention.

FIGS. 5A˜5C are schematic diagrams of embodiments with various configurations of the lens module in the IP camera apparatus.

FIGS. 6A˜6B and 7A˜7E are schematic diagrams of embodiments of the IP camera apparatus according to the invention.

FIG. 8 is a schematic diagram of an embodiment of the IP camera apparatus with another type of unified blocks mounted on an upper side or a lower side of the housing.

FIGS. 9A˜9C are schematic diagrams of mounting structure for the IP camera apparatus according to the invention.

### DETAILED DESCRIPTION

Certain terms are used throughout the following description and claim to refer to particular system components. As one skilled in the art will appreciate, manufacturers may refer to a component by different names. In the following discussion and in the claims, the terms “include” and “comprise” are used in an open-ended fashion. Also, the term “couple” is intended to mean either an indirect or direct electrical connection. Thus, if a first device is coupled to a second device, that connection may be through a direct electrical connection, or through an indirect electrical connection via other devices and connections.

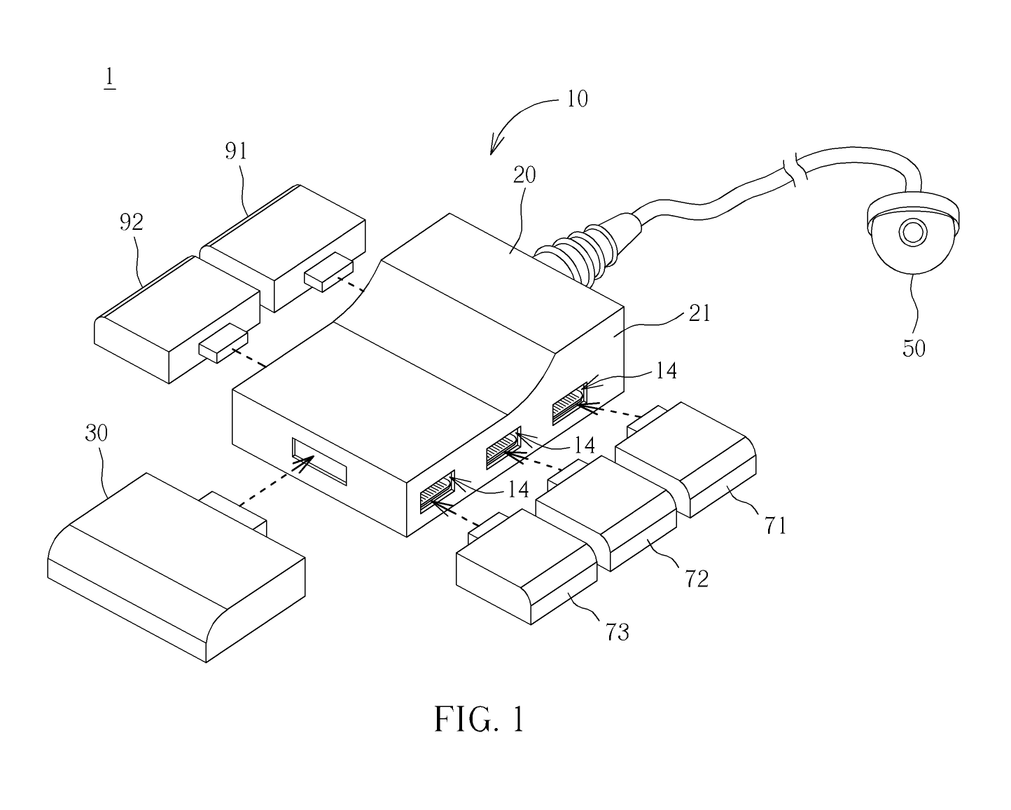

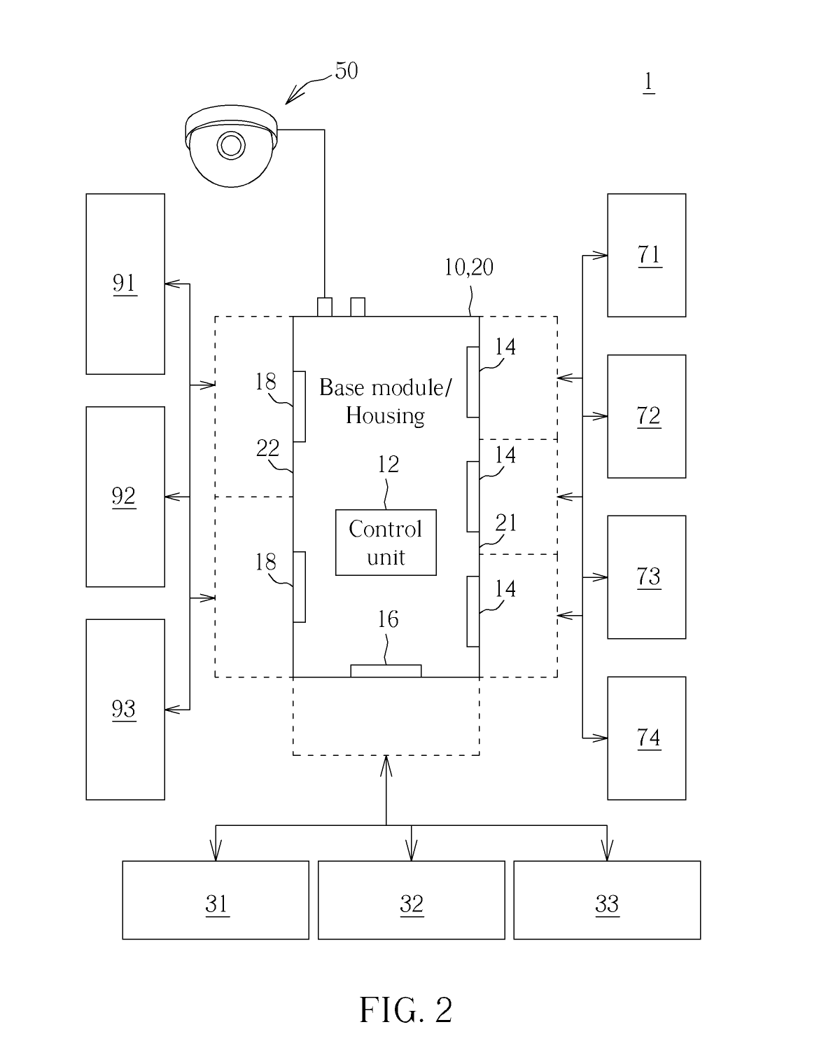

Please refer to FIG. 1. FIG. 1 is a schematic diagram of an embodiment of an IP camera apparatus according to the invention. An IP camera apparatus 1 is provided with extensible functional modules implemented in the form of unified blocks. The IP camera apparatus 1 includes a base module 10, a power module 30, at least a lens module 50, and a plurality of first functional modules 71˜73 and a plurality of second functional modules 91, 92. The base module 10 is formed in a housing 20 having a first docking side 21 and a second docking side 22. In the embodiment, the housing 20 is substantially a rectangular box with the first docking side 21 and the second docking side 22 equal in length. However, other embodiments of the invention may also come with housing in different form and the first docking side 21 may be in different length from the second docking side 22. A plurality of connecting ports 14, 18 is disposed on the first docking side 21 and the second docking side 22. The plurality of connecting ports 14, 18 are universal connecting ports cooperatively and adaptively connecting to each of the first functional modules 71˜73 and the second functional modules 91, 92. The universal connecting ports are universal I/O including power, plug detection, data lines, and GPIO, providing an interface through which for all accessories (the functional modules) to communicate with a control unit 12 (referring to FIG. 2) of the base module 10.

Please also refer to FIG. 2, which is a schematic diagram showing an illustrative block function diagram of the IP camera apparatus of FIG. 1 according to the invention. The power module 30 is detachably mounted to the base module 10 through a dedicated power I/O 16, which is not sharable with the universal I/O. Signals content of the power I/O 16 includes power and Ethernet for satisfying variety of customer needs. In the embodiment, the power module 30 may be implemented as a vehicle power module 31, an AC/DC power module 32, or a power-over-Ethernet (POE) module 33. The lens module(s) 50 is connected to the base module 10, either fixedly attached or detachably mounted to the housing 20, in such a way that the IP camera apparatus 1 is preferably a multi-lens IP camera system.

Functional modules with extension features are provided to the IP camera apparatus 1 as a building block with high flexibility of configuration of each functional module in different position of the housing 1. For example, the embodiment in FIG. 2 provides at least two sets of unified blocks that the functional modules can be implemented. The first functional modules 71˜74 are formed into a first unified block. Each of the first functional modules 71˜74 is the same in shape. Each first functional module 71˜74 can be detachably and interchangeably mounted to one of the plurality of connecting ports 14 on the first docking side 21 of the housing 20. The second functional modules 91˜93 are formed into a second unified block. Each of the second functional modules 91˜93 is the same in shape. Each second functional module 91˜93 can be detachably and interchangeably mounted to one of the plurality of connecting ports 18 on the second docking side 22 of the housing 20.

Besides the functional modules, in the embodiment of the invention, the lens module (s) 50 may also be implemented in the form of the first unified block as the first functional modules 71˜74 or the second unified block as the second functional modules 91˜93, so as to be mounted to the connecting port 14 at the first docking side 21 or the connecting port 18 at the second docking side 22. It should be noted that, for having interchangeability of the functional modules with same unified block, the position of the connecting ports 14, 18 and the corresponding connectors (not numbered) of each functional module should be configured consistently.

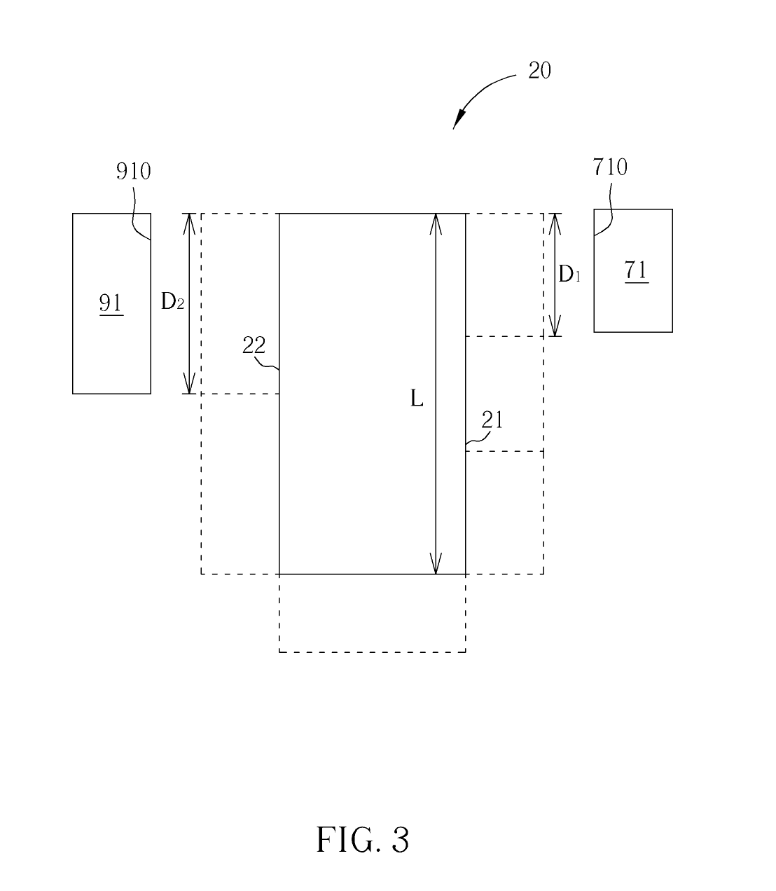

Variations of configuring the functional modules are provided by first referring to FIG. 3, which shows dimensional relations between the docking sides of the housing and the functional modules. In FIG. 3, taking the first docking side 21 and the second docking side 22 equal in length as the example, the functional module 71 in the form of the first unified block has length of a first unit length D₁ along a mounting side 710 and the functional module 91 in the form of the second unified block has length of a second unit length D₂ along a mounting side 910. Both the first docking side 21 and the second docking side 22 have length L. It is obvious that in the embodiment shown in FIG. 3, L is 3 times the first unit length D₁ and 2 times the second unit length D₂. In other words, the first docking side 21 of the housing 20 of the embodiment in FIG. 3 is capable or receiving at most three of the first functional modules 71˜74 in the form of first unified block and the second docking side 22 of the housing 20 is capable of receiving at most two second functional modules 91˜93 in the form of second unified block.

Since the functional modules intended to be mounted to the first docking side 21 have a first unit length D₁, the first functional modules 71˜74 can also be designed to have a mounting side 710 twice or thrice the first unit length D₁ as for the embodiment in FIG. 3. To put it in a generalized way, each first functional module 71˜74 has length of M times the first unit length D₁ along the mounting side 710 of the first functional module 71˜74, whereas the length L of the first docking side 21 is N times the first unit length D₁, and M, N are positive integers with M no greater than N. For example, in FIG. 3, N is 3 and M can be 1, 2, or 3 and the first functional modules 71˜74 can be one size, double size, or triple size in length (along the mounting side 710). Similarly, since the functional modules intended to be mounted to the second docking side 22 have a second unit length D₂, the second functional modules 91˜93 can also be designed to have a mounting side 910 twice the second unit length D₂ as for the embodiment in FIG. 3. To put it in a generalized way, each second functional module 91˜93 has length of X times the second unit length D₂ along the mounting side 910 of the second functional module 91˜93, whereas the length L of the second docking side 22 is Y times the second unit length D₂, and X, Y are positive integers with X no greater than Y. For example, in FIG. 3, Y is 2 and M can be 1 or 2 and the second functional modules 91˜93 can be one size or double size in length (along the mounting side 910).

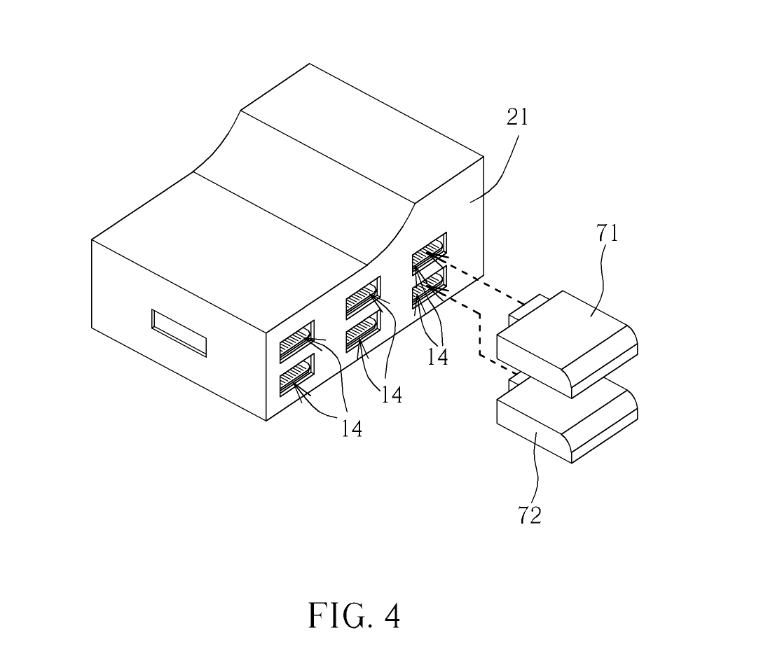

Please refer to FIG. 4. FIG. 4 is a schematic diagram of another embodiment of the IP camera apparatus according to the invention. Besides the length relation between the base module 10 and the functional modules, the IP camera apparatus 1 may also be provided with thickness capable of receiving more than one row of functional modules. As in the embodiment in FIG. 4, for example, the first docking side 21 has thickness at least two times the thickness of each first functional module 71˜74 and the plurality of connecting ports 14 are disposed on the first docking side 21 in at least two rows. Regarding the second docking side 22, the thickness may be the same as the first docking side 21 that is capable of receiving at least two rows of second functional modules 91˜93, but it is not necessary to be so. The IP camera apparatus 1 can also be formed in the shape of variant thickness in different docking sides.

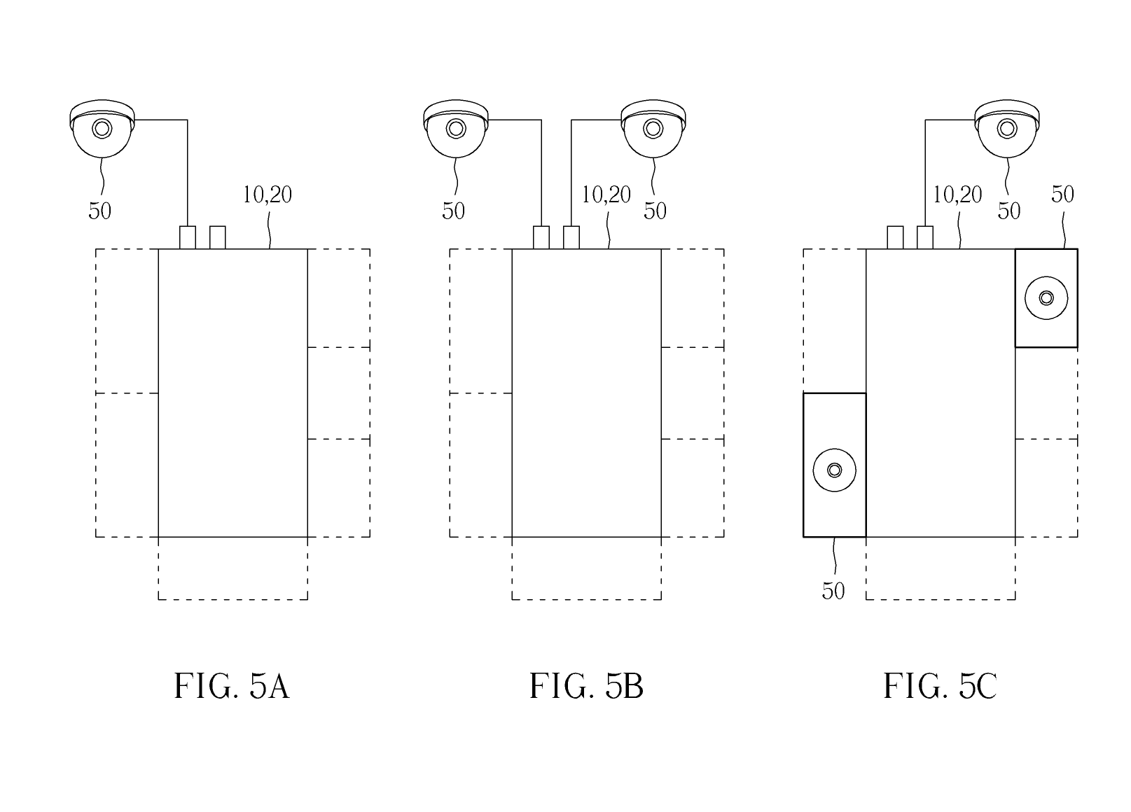

Please refer to FIGS. 5A˜5C, which are schematic diagrams of embodiments with various configurations of the lens module in the IP camera apparatus. In FIG. 5A, one lens module 50 is mounted to the base module 10 at a dedicated port. In FIG. 5B, two lens modules 50 are mounted to the base module 10 at the dedicated ports. In FIG. 5C, one lens module 50 is mounted to the base module 10 at a dedicated port, one lens module 50 is in the form of the first unified block and is mounted to one of the connecting port at the first docking side, and one lens module 50 is in the form of the second unified block and is mounted to one of the connecting port at the second docking side.

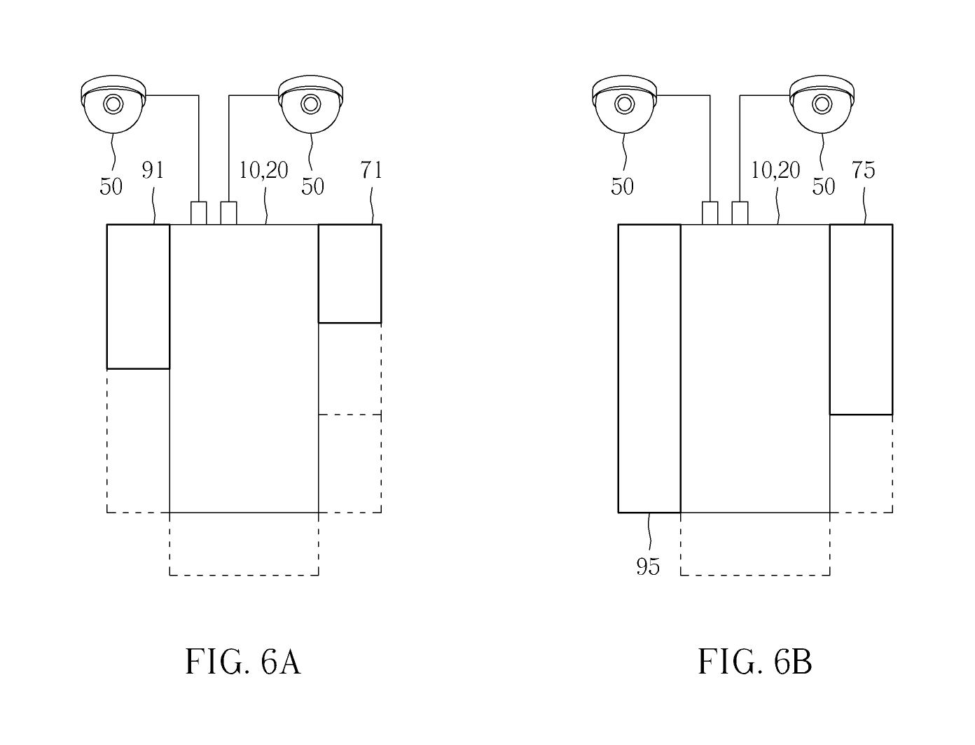

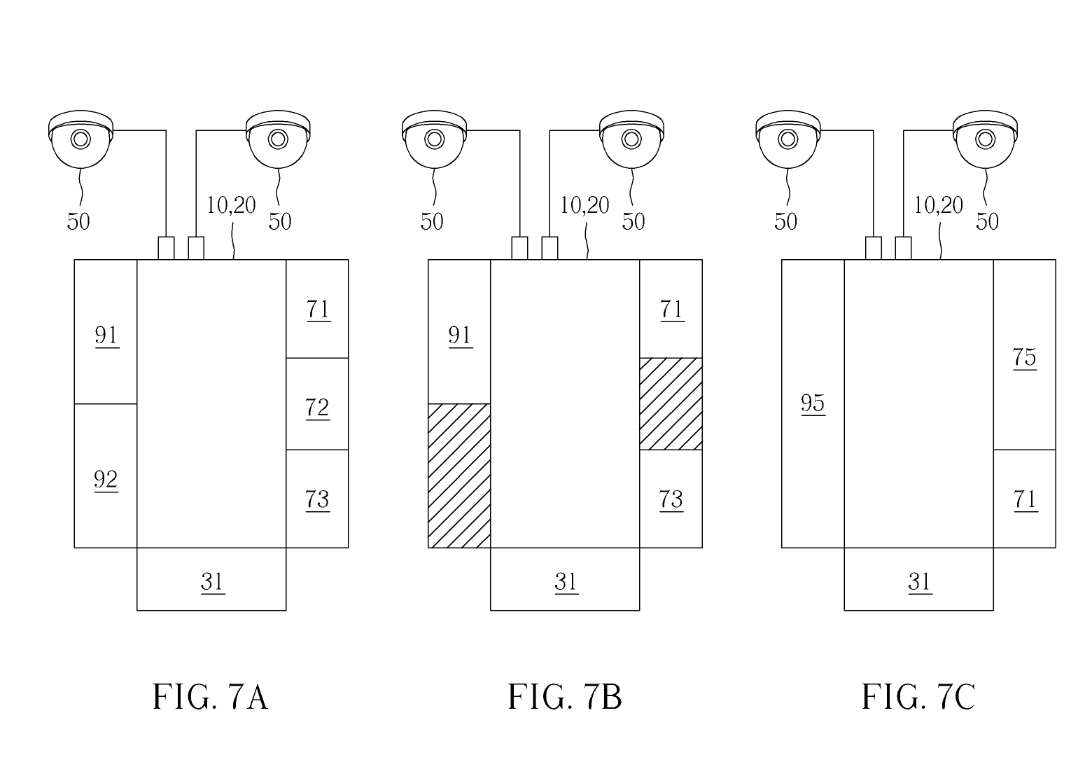

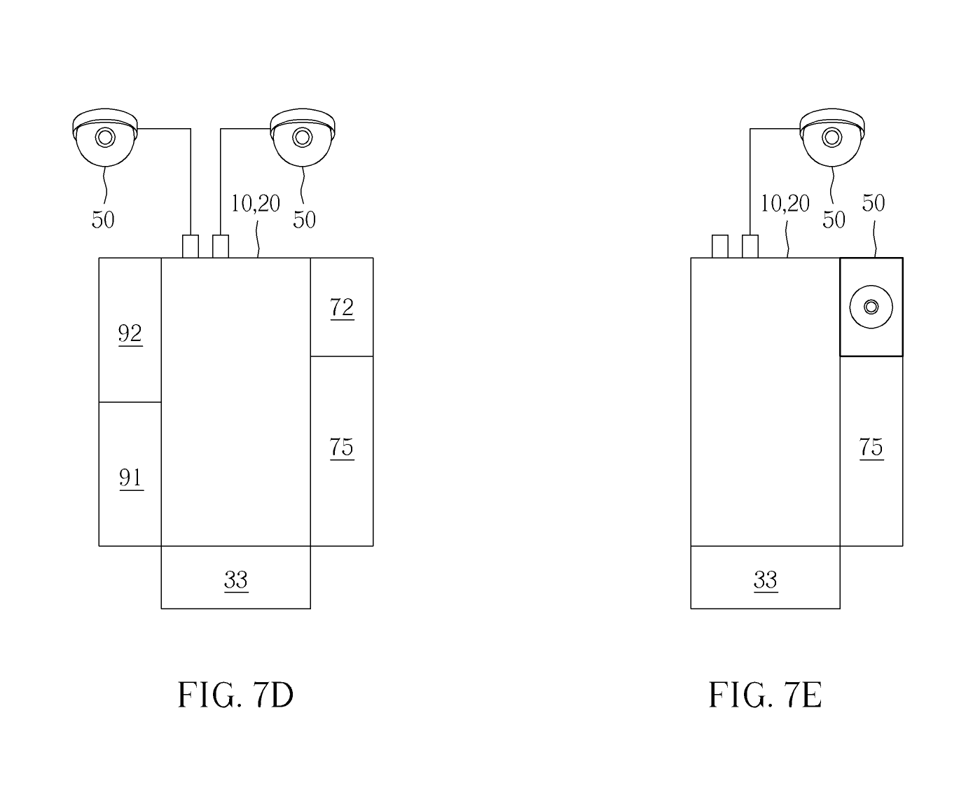

Please refer to FIGS. 6A˜6B and 7A˜7E, which are schematic diagrams of embodiments of the IP camera apparatus according to the invention. In the embodiments, each of the first functional modules 71˜74 and the second functional modules 91˜93 may be selected from one of the following: an audio box, an access control unit, a fire detector, a Wi-Fi module, a GPS module, a 3G communication module, and a 4G/LTE communication module. For example, in the embodiment of FIG. 6A, one first functional module 71 with the first unit length is mounted to one connecting port of the first docking side, while the rest of the connecting ports of the first docking side remain unplugged, and one second functional module 91 with the second unit length is mounted to one connecting port of the second side, while the other connecting port of the second docking side remains unplugged. In the embodiment of FIG. 6B, one first functional module 75 with double size the first unified block is mounted to one connecting port (the top one or the middle one) of the first docking side, while the rest of the connecting port (the bottom one) of the first docking side remains unplugged, and one second functional module 95 with double size the second unified block is mounted to one connecting port (the upper one or the lower one) of the second side, while the other connecting port of the second docking side remains unplugged.

As for the embodiment in FIG. 7A, three first functional modules 71˜73 with the first unit length are mounted to the connecting ports of the first docking side, two second functional modules 91˜92 with the second unit length are mounted to the connecting ports of the second docking side, the vehicle power module 31 is mounted to the base module 10 as a power source. For the embodiment in FIG. 7B, one dummy load (no embedded function but simply a mounted block) at each docking side is provided so that the IP camera apparatus 1 can be integrally shaped when there are connecting ports at the docking sides left empty and no functional modules in the neighborhood are covering the connecting ports. For the embodiment in FIG. 7C, two lens modules 50, one first functional module 75 with double size the first unified block, one first functional module 71 of the first unified bock, one second functional module 95 with double size the second unified block, and the AC/DC power module 32 are provided to the base module 10. For the embodiment in FIG. 7D, two lens modules 50, one first functional module 75 with double size the first unified block (dispose at the lower part of the first docking side), one first functional module 72 of the first unified bock, two second functional modules 91˜92 with the second unified block, and the power-over-Ethernet (POE) module 33 are provided to the base module 10. For the embodiment in FIG. 7E, one lens module 50 mounted at a dedicated port, one first functional module 75 with double size the first unified block (dispose at the lower part of the first docking side), one lens module 50 of the first unified bock, and the power-over-Ethernet (POE) module 33 are provided to the base module 10.

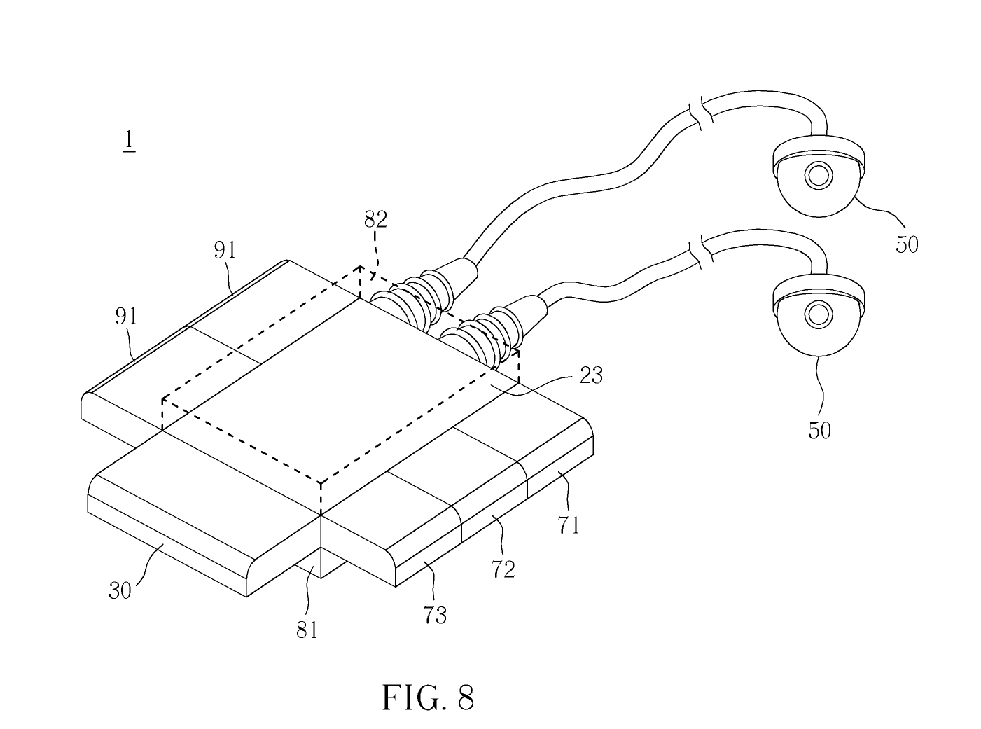

Please refer to FIG. 8. FIG. 8 is a schematic diagram of an embodiment of the IP camera apparatus with another type of unified blocks mounted on an upper side or a lower side of the housing. The embodiment in FIG. 8 shows how the feature of extensible functional modules implemented in the form of unified blocks can have even more options. The upper side 23 and the lower side (invisible from the angle of view in FIG. 8) of the housing 20 may also be made to provide room for expansion of another functional modules formed into a third unified block. For example, Any module that is implemented as the first functional modules 71˜73 or the second functional modules 91˜92, or even the lens module 50 or the power module 30 is also ready to be implemented as functional modules 81, 82 in the form the third unified block.

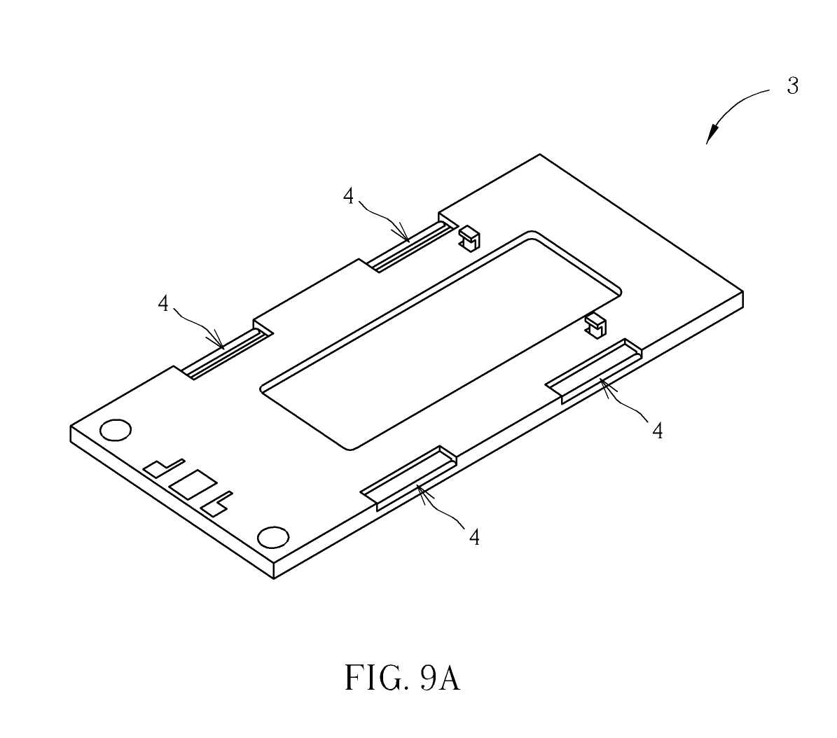

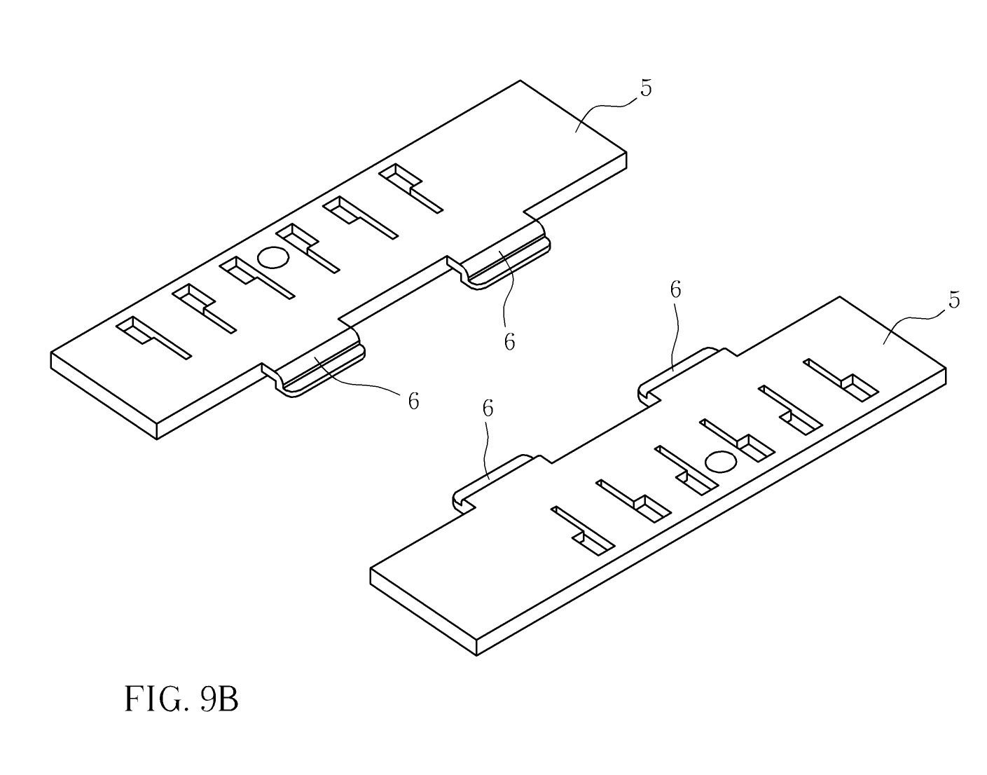

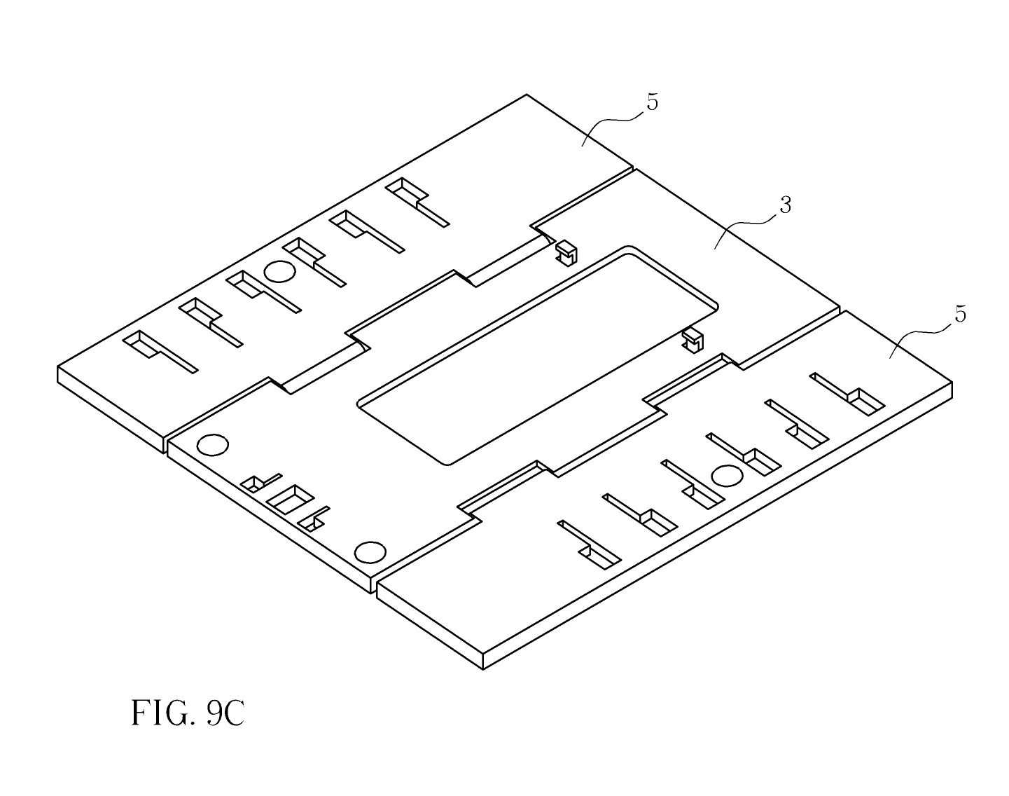

Please refer to FIGS. 9A˜9C, which are schematic diagrams of mounting structure for the IP camera apparatus according to the invention. The IP camera apparatus 1 of the embodiment further uses a base mount 3 as shown in FIG. 9A so that the base module 10 can be mounted on the base mount 3. The base mount 3 is further mounted to a wall or a ceiling so as to mount the IP camera apparatus 1 thereon. Referring to FIG. 9A, the base mount 3 has a plurality of first coupling parts 4. Referring to FIG. 9B, the IP camera apparatus 1 further includes a plurality of mounting kits 5 wherein the plurality of first functional module 71˜74 and the plurality of second functional modules 91˜93 may be mounted thereon. The plurality of mounting kits 5 has a plurality of second coupling parts 6 for coupling with the first coupling parts 4 of the base mount 3 (as shown in FIG. 9C) in a detachable way such that when the first functional modules 71˜74 and the second functional modules 91˜93 are mounted to the base module 10, these functional modules can be well supported by the mounting kits 5.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An IP camera apparatus, comprising:
a base module formed in a housing having a first docking side, the base module comprising a control unit, a plurality of connecting ports disposed on the first docking side;
a power module detachably mounted to the base module;
a lens module connected to the base module; and
a plurality of first functional modules detachably and interchangeably mounted to the plurality of connecting ports on the first docking side of the housing, each first functional module formed into a first unified block.

2. The IP camera apparatus of claim 1, wherein the lens module is detachably mounted to one connecting port on the first docking side of the housing and is formed into the first unified block.

3. The IP camera apparatus of claim 1, wherein each first functional module has length of M times a first unit length along a mounting side of the first functional module and the length of the first docking side is N times the first unit length, wherein M, N are positive integers and M is no greater than N, and wherein N connecting ports are disposed on the first docking side.

4. The IP camera apparatus of claim 1, wherein the first docking side has thickness at least two times the thickness of each first functional module and the plurality of connecting ports are disposed on the first docking side in at least two rows.

5. The IP camera apparatus of claim 1, wherein the housing further comprises a second docking side and a plurality of connecting ports is disposed on the second docking side.

6. The IP camera apparatus of claim 5, further comprising a plurality of second functional modules detachably and interchangeably mounted to the plurality of connecting ports on the second docking side of the housing, each second functional module formed into a second unified block.

7. The IP camera apparatus of claim 6, wherein the lens module is detachably mounted to one connecting port on the second docking side of the housing and is formed into the second unified block.

8. The IP camera apparatus of claim 6, wherein each second functional module has length of X times a second unit length along amounting side of the second functional module and the length of the second docking side is Y times the second unit length, wherein X, Y are positive integers and X is no greater than Y, and wherein Y connecting ports are disposed on the second docking side.

9. The IP camera apparatus of claim 8, wherein the first docking side and the second docking side are equal in length.

10. The IP camera apparatus of claim 6, wherein the second docking side has thickness at least two times the thickness of each second functional module and the plurality of connecting ports are disposed on the second docking side in at least two rows.

11. The IP camera apparatus of claim 6, wherein the plurality of connecting ports on the first docking side and the second docking side are universal connecting ports cooperatively and adaptively connecting to the plurality of first functional modules and the plurality of second functional modules.

12. The IP camera apparatus of claim 6, wherein each of the first functional modules and the second functional modules is selected from one of the following: an audio box, an access control unit, a fire detector, a Wi-Fi module, a GPS module, a 3G communication module, and a 4G/LTE communication module.

13. The IP camera apparatus of claim 1, wherein the power module is a vehicle power module, an AC/DC power module, or a power-over-Ethernet (POE) module.

14. The IP camera apparatus of claim 1, further comprising a base mount where the base module is mounted thereon and a plurality of mounting kits where the plurality of first functional modules and a plurality of second functional modules is mounted thereon respectively, each of the mounting kit coupled with the base mount in a detachable way.
